(19) United States
(12) Patent Application Publication
(10) Pub. No.: US 2010/0202001 A1
(43) Pub. Date: Aug. 12, 2010

(54) ANATOMICALLY REALISTIC THREE DIMENSIONAL PHANTOMS FOR MEDICAL IMAGING

(76) Inventors: Michael A. Miller, Indianapolis, IN (US); Gary D. Hutchins, Carmel, IN (US)

Correspondence Address: ICE MILLER LLP, ONE AMERICAN SQUARE, SUITE 3100, INDIANAPOLIS, IN, 46282-0200, US

(21) Appl. No.: 12/668,989

(22) PCT Filed: Jul. 16, 2008
(86) PCT No.: PCT/US08/70135

§ 371 Date: Mar. 1, 2010

Related U.S. Application Data
(60) Provisional application No. 60/949,967, filed on Jul. 16, 2007.

(51) Int. Cl. G06K 9/00; G06F 15/00

(52) U.S. Cl. 358/1.9; 382/132

(57) ABSTRACT

This application generally relates to the field of medical imaging. According to certain embodiments, anatomically accurate phantoms with tunable activity concentrations and x-ray attenuation coefficients for use in positron emission tomography and positron emission tomography/x-ray computed tomography are created by utilizing a three dimensional printer. According to certain embodiments, radiolabeled or x-ray contrast material is added to a binder used in a three dimensional printer, and the resultant radiolabeled or x-ray contrast binder is selectively used to bind a prototype powder into an accurate scanning rendition of a selected portion of anatomy. By utilizing one or more radiolabeled or x-ray contrast binders, multiple tissue densities can be present in a single phantom, with complex geometries rendered therein.

This International Patent Application claims priority to U.S. Provisional Patent Application No. 60/949,967, entitled “Anatomically Realistic Three Dimensional Phantoms for Medical Imaging,” filed Jul. 16, 2007, which is incorporated herein by reference.

### BACKGROUND

This application generally relates to the field of imaging. More particularly, the present application relates to medical imaging.

Anatomical models of organs and body parts, or of geometric shapes, are frequently used in the field of imaging to provide a model by which to calibrate imaging equipment including medical imaging equipment encompassing computed tomography, magnetic resonance imaging, x-ray technology, positron emission tomography, single photon emission computed tomography, radionuclide imaging, computed radiography, ultrasonography, and various other equipment to standardize or account for differences in results obtained in clinical studies that are performed with multiple imaging systems, often in multiple geographic locations. These models, typically referred to as “phantoms”, are used to help engineers, scientists and technicians calibrate and characterize imaging equipment. Further, phantoms are used to calibrate equipment to reduce image noise and to optimize imaging equipment to view particular tissue types or anatomical features.

Practitioners will appreciate that each body part, healthy or diseased, presents a distinct challenge in optimizing the medical imaging equipment's ability to image the body part. By utilizing a phantom that accurately portrays a particular body part, both in shape and apparent mass density of the tissue, medical imaging equipment can be more precisely calibrated, thereby allowing greater precision and accuracy in clinical applications and research into both medical imaging equipment and the disease states imaged.

Presently, phantoms typically used in medical imaging comprise a hollow cavity in the shape of an organ or model filled with a radioisotope liquid mixture or a radioisotope impregnated resin or epoxy. In order to adjust the radionuclide concentrations of present phantoms to approximate differing tissue types in an organ or body part, multiple cavities may be used, along with different liquids or resins having varying concentrations of radioisotopes. These fillable cavities in complex and/or small geometries present a challenge to machine to an appropriate shape while still retaining their ability to be filled with a radioisotope liquid mixture or a radioisotope impregnated resin or epoxy. Finally, because the phantoms presently used in medical imaging typically include fillable hollow cavities, they must include relatively thick walls surrounding these cavities. The presence of these walls can have a deleterious effect on quantitative results obtained by imaging such phantoms.

### SUMMARY

According to at least one embodiment, a phantom for use in medical imaging comprises a powdered material that can be bound to itself or another powdered material with a binder composition, forming a three dimensional model; a binder material that can be applied to the one or more powdered materials to form a solid or semi-solid material when cured, with the binder being able to be combined with a radioactive material, x-ray contrast material, or a combination of both a radioactive material and x-ray material; and at least one material chosen from the group consisting of a radioactive material, an x-ray contrast material, or a combination of a radioactive material and x-ray material and powder.

In at least one embodiment, the phantom described above is modeled after a three dimensional rendering of an anatomical feature, and the phantom deviates from the rendering by less than or equal to 0.25 mm in the vertical axis of the phantom. In at least one embodiment, the phantom described above is modeled after a three dimensional rendering of an anatomical feature, and the phantom deviates from the rendering by less than or equal to 0.1 mm in the horizontal axis of the phantom. In at least one embodiment, the phantom described above is modeled after a three dimensional rendering of an anatomical feature, and the phantom deviates from the rendering by less than or equal to 0.25 mm in the vertical axis of the phantom and deviates from the rendering by less than or equal to 0.1 mm in the horizontal axis of the phantom.

In at least one embodiment, the phantom described above uses at least two materials to represent the density of two or more tissues shown in the three dimensional rendering of an anatomical feature. Further, in at least one embodiment, the phantom is made by utilizing data from a positron emission tomography, x-ray computed tomography, magnetic resonance imaging scan, or other imaging modality, to produce the three dimensional rendering. In yet another embodiment, at least one material chosen from either a radioactive material, an x-ray material, or both is combined with the binder and selectively added to a powdered material to form a cross section of the three dimensional rendering. In an additional embodiment, multiple cross sections of the three dimensional rendering are formed in successive order to produce a three dimensional phantom.

In at least one embodiment of the phantom described above, the at least one material chosen from the group consisting of a radioactive material, an x-ray contrast material, or a combination of a radioactive material and x-ray material combined with the binder composition is selectively added to the powdered material to form at least one cross section of the three dimensional rendering of an anatomical feature. Optionally, the phantom further comprises a first cross section and a second cross section of the three dimensional rendering of an anatomical figure, whereby the second cross section of the three dimensional rendering of an anatomical figure is iteratively formed upon the first cross section of the three dimensional rendering to form a three dimensional phantom.

In at least one embodiment, methods of making at least one embodiment of the phantom are described. The method of making the phantom, according to at least one embodiment, comprises the steps of obtaining a digital model of a structure, introducing the digital model to a three-dimensional printer, whereby the three-dimensional printer comprises a printing mechanism, a powder, and at least one binding agent. Following the introduction of the digital model to the three-dimensional printer, the three-dimensional printer distributes a layer of the powder on a solid surface, and distributes a layer of a binding agent on the powder, whereby the binding agent adheres upon contact with the powder. Optionally, the step of distribution of powder and the distribution of a binding agent may be repeated at least one additional time as needed to increase the volume of the phantom.

In at least one embodiment, methods of using at least one embodiment of the phantom are described. The method of using the phantom, according to at least one embodiment, comprises portraying a structure substantially similar in both shape and apparent mass density.

In at least one embodiment, the phantom may be used for the quantitative evaluation of an imaging system. A method of quantitative evaluation of an imaging system, according to at least one embodiment, using an embodiment of the phantom, comprises the steps of providing the phantom with a previously determined image, providing an imaging system, visualizing the phantom with the imaging system to obtain a first image of the phantom, and determining the variation between the first image and the predetermined image using a processor. Optionally, according to at least one embodiment, the method of quantitative evaluation of an imaging system may further comprise calibrating the imaging system, whereby the method of calibrating comprises the steps of altering at least one variable in the imaging system so that visualization of the phantom with the imaging system produces a second image is substantially the same as the previously determined image.

In at least one embodiment, a method of representing a physiologic condition using an embodiment of the phantom, wherein the method comprises the steps of creating a phantom having an anatomic and non-uniform representation of an anatomic feature substantially identical to the anatomic feature, and verifying that the image developed of the phantom through use of an imaging system is substantially identical to an anatomic image developed of the anatomic feature through the use of the imaging system.

### BRIEF DESCRIPTION OF THE DRAWINGS

FIG. 1 is a photograph of five separate phantoms according to at least one embodiment of the present application, as compared to a centimeter scale.

FIG. 2 is a PET image of three of the phantoms shown in FIG. 1.

FIG. 3 is a PET image of two of the phantoms shown in FIG. 1.

FIG. 4 is a digital model of a skull utilized to produce a phantom according to at least one embodiment of the present application.

FIG. 5 is a digital model of a brain within the skull shown in FIG. 4, utilized to produce a phantom according to at least one embodiment of the present application.

FIG. 6 is a digital model of a brain, showing the skull cap surrounding a radiolabeled cross-section of the brain shown in FIG. 5, utilized to produce a phantom according to at least one embodiment of the present application.

FIG. 7 is a digital model of a cross-section of the brain of FIG. 5, utilized to produce a phantom according to at least one embodiment of the present application.

FIG. 8 is a digital model of the cross-section of the brain shown in FIG. 7, showing the portion of the skull and caps containing the phantom.

FIG. 9 is a photograph of the resultant phantom comprising a cross-section of the brain and skull as modeled in FIG. 8, as compared to a centimeter scale.

FIG. 10 is a CT image of the phantom of FIG. 9.

FIG. 11 is a PET image of the phantom of FIG. 9.

FIG. 12 is a fused PET/CT image of the phantom of FIG. 9.

FIG. 13 is a bitmap image of a brain according to at least one embodiment of the application.

FIG. 14 is a photograph of a printer creating a bitmap layer according to at least one embodiment of the application.

FIG. 15 is a photograph of a phantom of a brain according to at least one embodiment of the application.

FIG. 16 is a PET image of the brain phantom of FIG. 15 according to at least one embodiment of the application.

FIG. 17 is a bitmap image of a brain including calibration spots according to at least one embodiment of the application.

FIG. 18 shows a graphical representation of a radionuclide concentration calibration curve, according to at least one embodiment of the disclosure.

FIG. 19A is a CT image of a human torso, focused on a human lung with a cancerous nodule to be modeled such that a phantom is produced according to one embodiment of the present application.

FIG. 19B is a CT image of a phantom of the human lung modeled after the CT image shown in FIG. 19A.

FIG. 19C is an overlay of the CT image of a human lung and a CT image of the phantom produced from the original CT image of the human lung, displaying the accuracy of the models able to be produced by the methods disclosed herein.

FIG. 20 is a digital model produced from the CT image shown in FIG. 19A.

FIG. 21 is a photograph of the interior of a resultant phantom created according to one embodiment of the present application, created from the digital model of FIG. 20 as compared to a centimeter scale.

FIG. 22 is a close-up photograph of the phantom shown in FIG. 21, as compared to a centimeter scale.

FIG. 23 is a PET/CT image of an anatomical feature according to at least one embodiment of the application.

FIG. 24 is a bitmap/CT image of the anatomical feature of FIG. 23, according to at least one embodiment of the application.

FIG. 25 is a photograph of a printer producing a phantom using the bitmap image of FIG. 24, according to at least one embodiment of the application.

FIG. 26 is a photograph of the completed lung phantom of FIG. 25.

FIG. 27 is PET image of the lung phantom of FIG. 25 overlaid with the corresponding CT image of FIG. 23, according to at least one embodiment of the application.

### DETAILED DESCRIPTION

The present disclosure relates generally to the field of imaging. More particularly, the present application relates to medical imaging. For the purposes of promoting an understanding of the principles of the present disclosure, reference will now be made to the embodiments illustrated in the drawings, and specific language will be used to describe the same. It will nevertheless be understood that no limitation of the scope of the present disclosure is thereby intended.

The disclosed embodiments include phantoms, methods of making phantoms, and methods of their use. For example, at least some of the embodiments are useful for imaging. Such imaging, in at least an embodiment, allows for the investigation of resolution effects, and may optionally correct for them. Further, at least some embodiments disclosed obviate the need for fill-able cavities in phantoms.

According to at least one embodiment, a phantom comprises a three dimensional model of a complete organ, tissue, or organism, or a cross-section or portion or model thereof. Additionally, according to at least one embodiment, a phantom may comprise a three dimensional model of an inorganic or partially inorganic structure. Further, in at least one embodiment the phantom comprises a solid or semi-solid object having a consistent or variable concentration of a radioisotope distributed throughout the object in a predetermined form. Alternatively, in at least one embodiment, a consistent or variable concentration of an x-ray contrast material is distributed with, or instead of, the radioisotope to provide an apparent density similar to radiolabeled tissue or standard tissue for a modeled body part when imaged with medical imaging equipment. Further, in at least one embodiment, the radioisotope distributed through the phantom is of a non-uniform shape. Additionally, according to at least one embodiment, multiple regions of radioisotopes may be located within the phantom. According to at least one embodiment, the regions of radioisotopes within the phantoms may have substantially no barrier between them. In at least one embodiment, the barrier between the at least two regions may be separated by a distance of less than or equal to 0.014 inches, less than or equal to 0.007 inches, or by a distance that is substantially zero.

According to at least one embodiment, a phantom having a precisely determined distribution of radiolabeled material is created by combining radiopharmaceuticals or radioisotopes, such as [18F]FDG or 99 mTc compounds, with a three dimensional binder compound (a “binder”) such as those used for three dimensional rapid prototyping. According to at least one further embodiment, radioisotopes such as ⁶⁸Ge with longer half-lives may be incorporated in the phantom. Thereafter, the binder-radiopharmaceutical composition is loaded into a binder reservoir in a three dimensional printer. Other binder reservoirs optionally are filled with other radiopharmaceuticals, inks, or x-ray contrast materials to allow each binder mixture to be selected individually or in combination with other binder mixtures to create a mixture of the contents of each at the print head, much as different colors are combined in an ink jet printer to create non-primary colors.

Optionally, a wide range of radioisotopes or x-ray contrast materials are combined with the binder in varying concentrations to allow for a broad spectrum of radiolabeled or x-ray contrast effects to be injected into a prototyping powder. According to at least one embodiment, the prototyping powder is a cellulose-based powder, or other suitable powder. It will be appreciated that fine control of the concentration of radiolabeled or x-ray contrast material is achieved by utilizing the resolution of the three dimensional printer to radiolabel only certain portions or thicknesses of the phantom. By utilizing some or all of the reservoirs in the printer for the containment of different radiopharmaceuticals, x-ray contrast materials, or differing concentrations of radiopharmaceuticals or x-ray contrast materials mixed with the binder, and by controlling the amount of radiopharmaceuticals, x-ray contrast materials, or differing concentrations of radiopharmaceuticals or x-ray contrast materials mixed with the binder printed at each point, it will be appreciated that a vast array of radiolabeling and x-ray contrast effects are obtained.

According to at least one embodiment, a digital model of a structure is created. In at least one embodiment, the structure may be a rendering of an anatomical feature. The digital model may be created through use of computer-aided design (CAD) technology or an imaging technology such as computed tomography (CT), magnetic resonance imaging (MRI), x-ray technology, positron emission tomography (PET), single photon emission computed tomography, radionuclide imaging, computed radiography, or ultrasonography. Additionally, in at least one embodiment, combinations of two or more methods of generating digital models, such as PET and CT, of structures may be utilized to form a single depiction.

In at least one embodiment, the creation of a digital model or of the transfer of the model to a format usable by a three dimensional printer may incorporate one or more processors, computers, servers, and databases, each operable over one or more networks. The various functions of the computers, servers, databases, and networks, and the various configuration(s) and programming as may be recited herein, may be performed by computer software and/or computer hardware. Such computer software may be written in a well known language such as, for example, Basic, C, C++, Fortran, JavaScript, Java, Pascal, PERL, HTML, XML, or SQL, or a combination of any of the foregoing or the equivalents thereof.

In at least one embodiment, the digital model of a structure is exported by a processor to a data style, such as a computer-readable file (or files), such as a vtk file, and converted by a processor to a stereolithography format (stl) using the VTK libraries (www.vtk.org). STL files are directly readable by the printer software.

Thereafter, the digital model is utilized to build a model as specified in a stereolithography file created with computer-aided drafting software or other software program. In application, a three dimensional printer optionally builds a model by adding a powdered substance, such as powdered cellulose, and using the printer head of the ink jet to lay down a binder or binder-radiopharmaceutical or binder-contrast composition to bind the powdered cellulose into a solid form. The printer head iteratively builds each successive cross section of the model defined in the stereolithography file or bitmap, with each layer being built upon the previously built layer. The printer software is operable to selectively use any of the binder-contrast, binder-radiopharmaceuticals, or binder alone or in combination to iteratively build the three dimensional phantom.

Additionally, in at least one embodiment, the digital model of a structure is segmented using an appropriate software tool, such as Slicer (available from www.slicer.org), and the segments are used to generate a series of bitmaps of the images. Each point in the bitmap specifies the amount of radionuclide/binder mixture to be printed at that point. Since colors, in at least one embodiment, are specified by an eight bit index, relative binder concentrations can be specified by labeling each point in the bitmap with an index ranging from zero (no radionuclide/binder mixture) to 255 (maximum radionuclide/binder mixture). A bitmap is created for each layer of the three dimensional phantom. The printer is then driven to print the radionuclide/binder mixtures specified for each layer, with each layer being built upon the previously built layer. By utilizing the binder reservoirs in the printer system, the multiple combinations of radionuclide, x-ray contrast and binder can combined by preparing the appropriate mixtures for each color.

In at least one embodiment, the creation of bitmap and/or of the transfer of the bit to a three dimensional printer may incorporate one or more processors, computers, servers, and databases, each operable over one or more networks. The various functions of the computers, servers, databases, and networks, and the various configuration(s) and programming as may be recited herein, may be performed by computer software and/or computer hardware. Such computer software may be written in a well known language such as, for example, Basic, C, C++, Fortran, JavaScript, Java, Pascal, PERL, HTML, XML, or SQL, or a combination of any of the foregoing or the equivalents thereof.

Additionally, in at least one embodiment, the phantom formed from the digital model using an embodiment of the method described above has less than or equal to about 3% relative standard deviation, or less than or equal to about 2% relative standard deviation of an activity when compared to a second phantom produced by the same method.

It will be appreciated that fine printer resolutions of less than or equal to about 0.5 mm, less than or equal to about 0.25 mm, or less than or equal to about 0.18 mm vertical resolution can be accomplished according to various embodiments. Further, printer resolutions of less than or equal to about 0.2 mm, less than or equal to about 0.10 mm, or less than or equal to about 0.08 mm horizontal resolution can be accomplished according to various embodiments. Therefore, it will be appreciated that the embodiments according to the present application allow for more accurate modeling than previous phantom production techniques, and allow for smaller structures to be accurately portrayed. As such, phantoms created according to the present application allow for more detailed phantoms to be created. In fact, the resolution of phantom production according to at least one embodiment exceeds the resolution of most, if not all, current medical imaging technologies.

### Example I

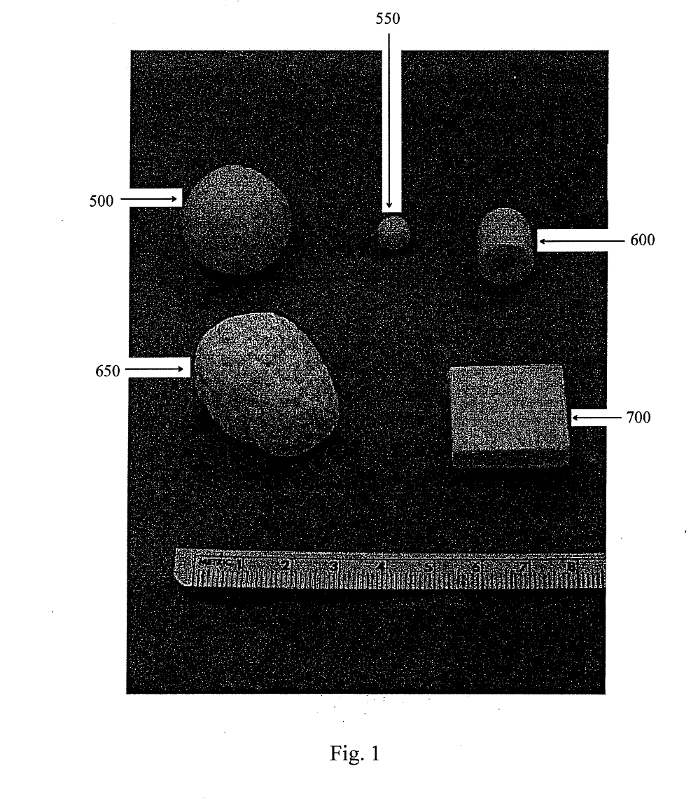

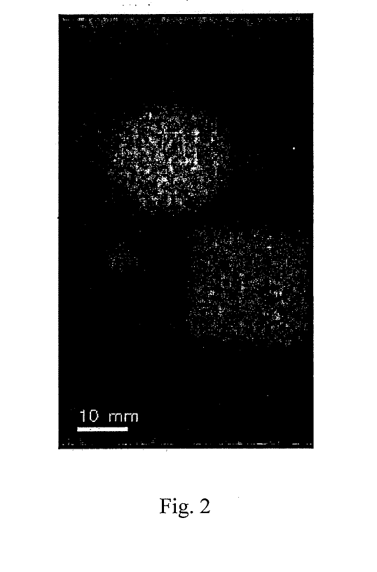

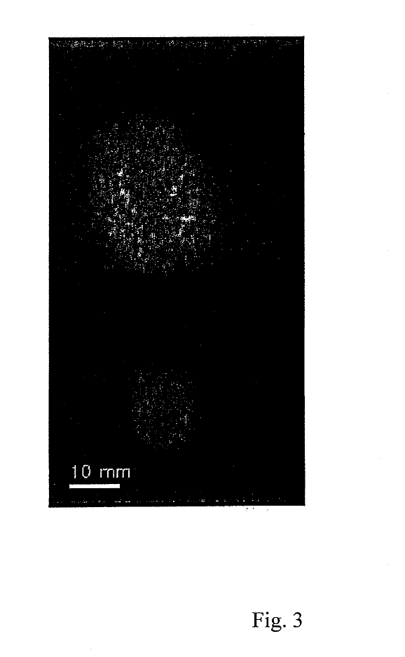

In one exemplary embodiment, several different phantoms were manufactured utilizing [18F]FDG added to a three dimensional printer binder to produce an activity concentration of about 11 kBq/mL. As shown in FIG. 1, the phantoms created in this example included a first sphere 500 having a diameter of 25 mm, a second sphere 550 having an 8 mm diameter, a bell-shaped phantom 600 intended as a model of a rat heart, a miniaturized human brain (based on the digital human brain atlas from the Surgical Planning Laboratory (Boston, Mass.) 650, and a rectangular slab 700. Each of the phantoms shown in FIG. 1 where created with volumes on the order of a few milliliters to allow several phantoms to be produced simultaneously as a first test of the method. These phantoms were then imaged for analysis. FIGS. 2 and 3 show positron emission tomography images of the phantoms displayed in FIG. 1.

To produce the phantoms specified above, a total of 500 mL of binder-radiotracer was prepared with an initial activity concentration of approximately 70 kBq/mL by adding approximately 35 MBq of [18F]FDG to 500 mL of binder. Allowing for the 18F decay (halflife=110 minutes), this resulted in an activity concentration of 56 kBq/mL at the end of the print job one hour later. The total volume of the phantoms was 24 mL, requiring total of 23 mL of binder. Based on our understanding of the printer specifications, 0.13 mL of binder is required for each mL of phantom, so we predicted an activity concentration of 0.13*56 kBq/mL=7.3 kBq/mL in the phantoms at the end of the print job.

Once the radiolabeled binder (also referred to as binder-radiopharmaceutical composition) was created, all clear binder was removed from the ink reservoir in the three dimensional printer, and all lines to the print head were cleared. Thereafter, the radiolabeled binder was inserted into the reservoir, with at least 200 mL more radiolabeled binder added to the reservoir than required to produce the total volume of all of the phantoms so that the feed lines from the reservoir to the print head of the three dimensional printer could be purged of any non-radiolabeled binder that might remain.

Thereafter, powder parameters for the three dimensional printer were set for ZP15E powder (available from Z Corporation of Burlington, Mass.) with shell and core saturation of 100% and 300%, respectively, to produce a uniform binder/volume ratio of 0.130. The three dimensional printer was thereafter activated, and approximately 80 mL of radiolabeled binder was bled through the print head. Thereafter, the five phantoms described above and illustrated in FIG. 1 were uploaded to the Spectrum Z510 (available from Z Corporation of Burlington, Mass.) three dimensional printer, with the scan uploaded to utilize the radiolabeled binder for the entire model production. The three dimensional printer took approximately 60 minutes to produce the five models in this example. Thereafter, each model was allowed to set up for an additional 30 minutes, thereby allowing the radiolabeled binder to dry completely on the powdered substrate. Once set and dry, any unbound powder was removed, revealing the completed phantom. Due to the radioactive nature of the phantom, all handling was performed with gloves and forceps, and the phantoms were placed within protective bags upon removal from the printer.

Each of the phantoms shown in FIG. 1 were thereafter produced according to this same methodology, with the models in this example including a first sphere 500 having a diameter of 25 mm, a second sphere 550 having an 8 mm diameter, a bell-shaped phantom 600 intended as a model of a rat heart, a miniaturized human brain 650, and a rectangular slab 700. Imaging was then performed on the completed phantoms using either ISAP and/or research PET scanners, a Siemens HR+PET scanner, or Siemens Biograph-16 PET/CT scanner. Images of these phantoms are shown in FIGS. 2 and 3.

The radioactivity in the smallest phantoms (the small sphere and model rat heart) and of samples of the binder-radiotracer mixture were assayed with a gamma counter (Beckman Gamma 8000) and calibrated against a 68Ge source (Isotope Products). The activity concentration in these two phantoms and the binder mixture, decay corrected to the end of the print job were 7.5, 7.4 and 71 kBq/mL respectively, indicating that the fraction of binder activity in the parts is 0.10, rather than the 0.13 expected.

### Example II

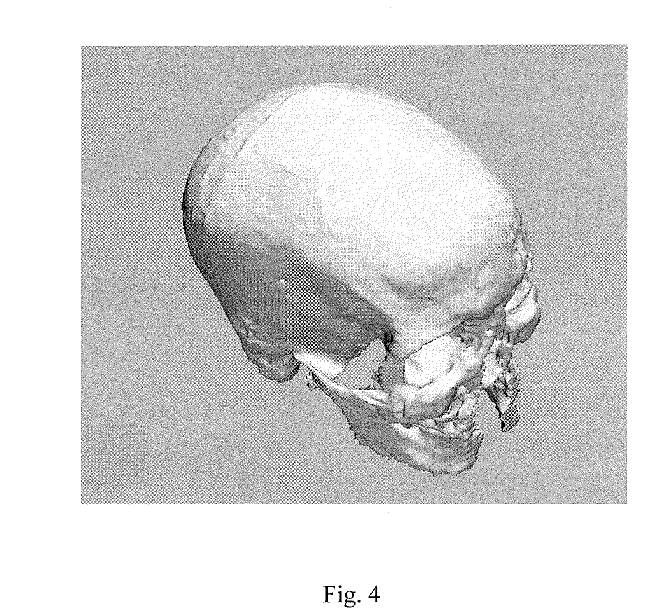

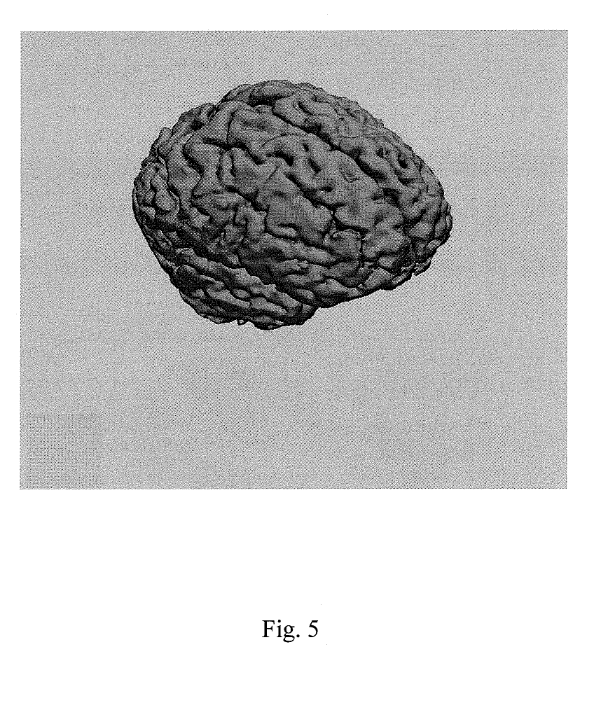

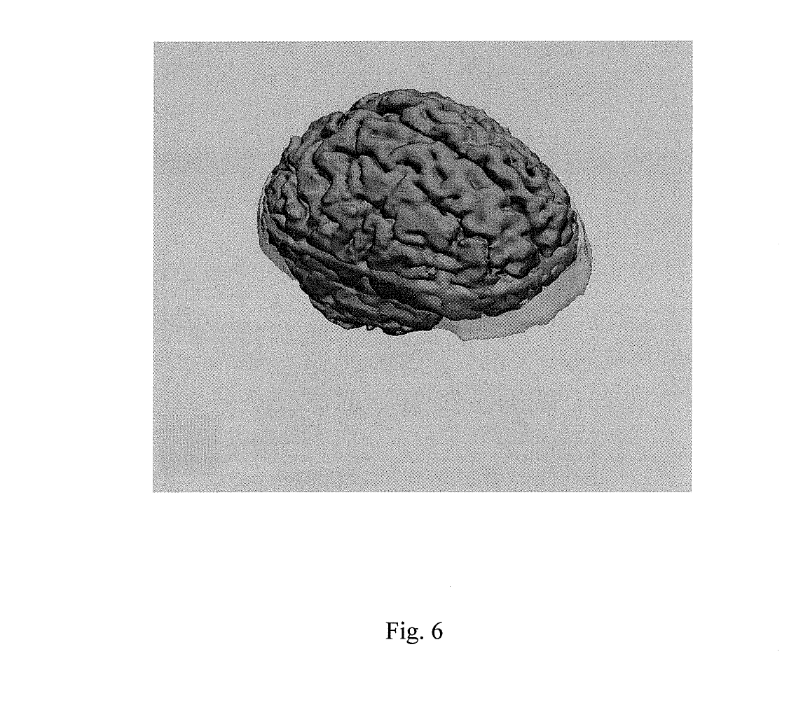

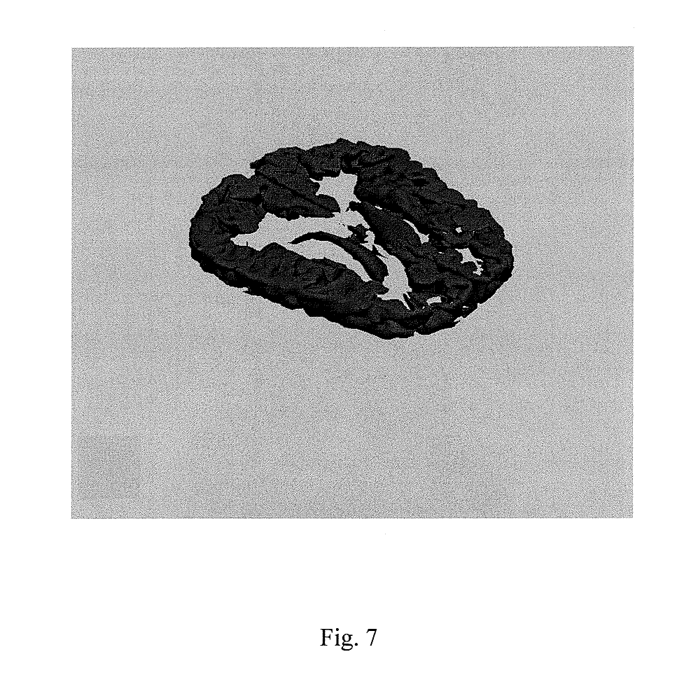

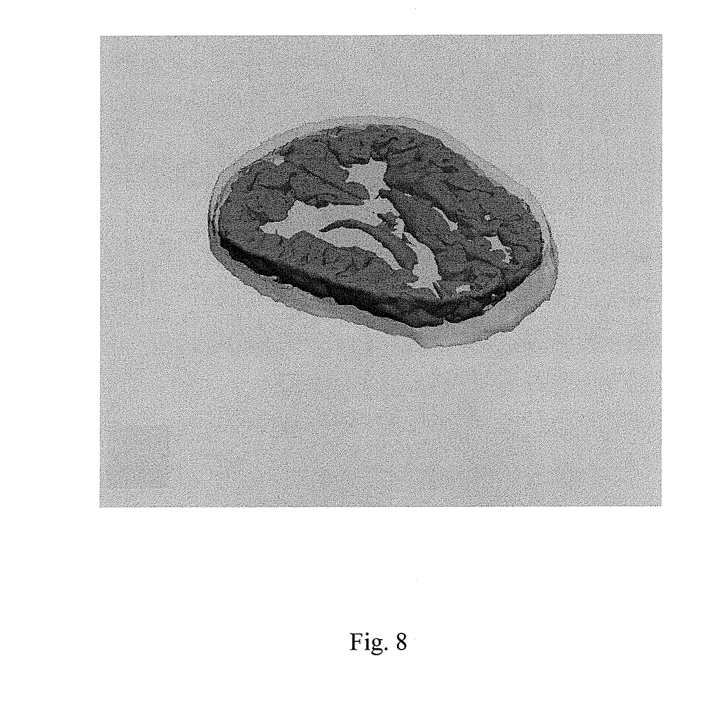

According to another exemplary embodiment, a life-sized phantom modeled after a human brain was produced from the digital brain atlas from the Surgical Planning Laboratory (Boston, Mass.). Utilizing this data, renderings of the human skull, brain, and cross-sections thereof as shown in FIGS. 4, 5, 6, 7, and 8 were input into the three dimensional printer, to create a brain phantom of a 15 mm thick brain slab contained within a case shaped like the surrounding skull and two caps. FIG. 4 shows the rendering of the skull case, FIG. 5 shows the rendering of the brain, FIG. 6 shows the rendering of the phantom and the brain, FIG. 7 shows the rendering of the radiolabeled portion of the phantom, and FIG. 8 shows the rendering of the radiolabeled portion of the phantom and case. Thereafter, these renderings were input into a three dimensional printer, namely the Spectrum Z510 (Z Corporation of Burlington, Mass.), and a complete brain phantom was created according to a method as discussed above in Example I.

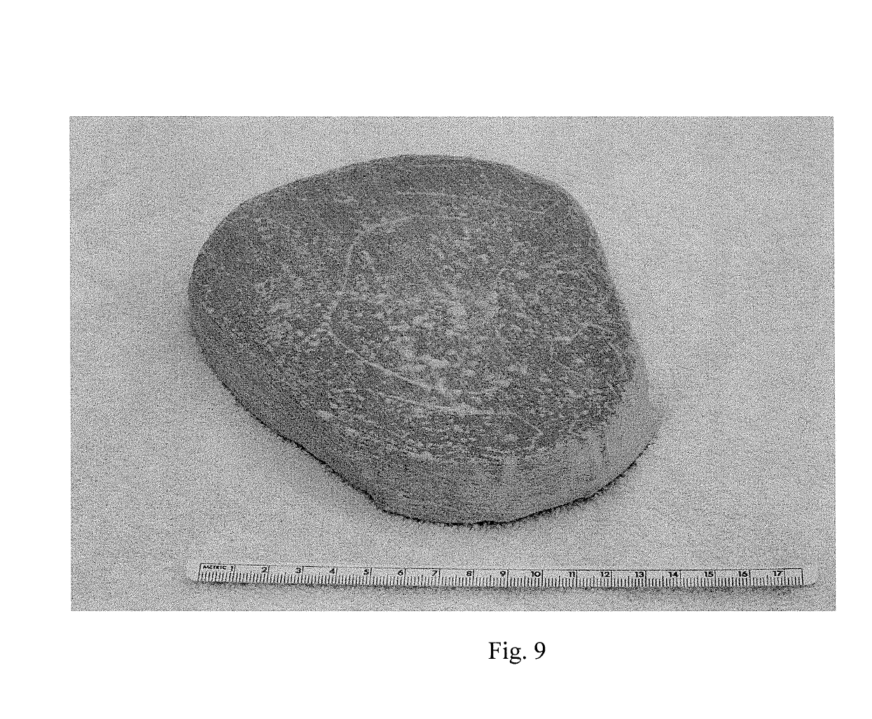

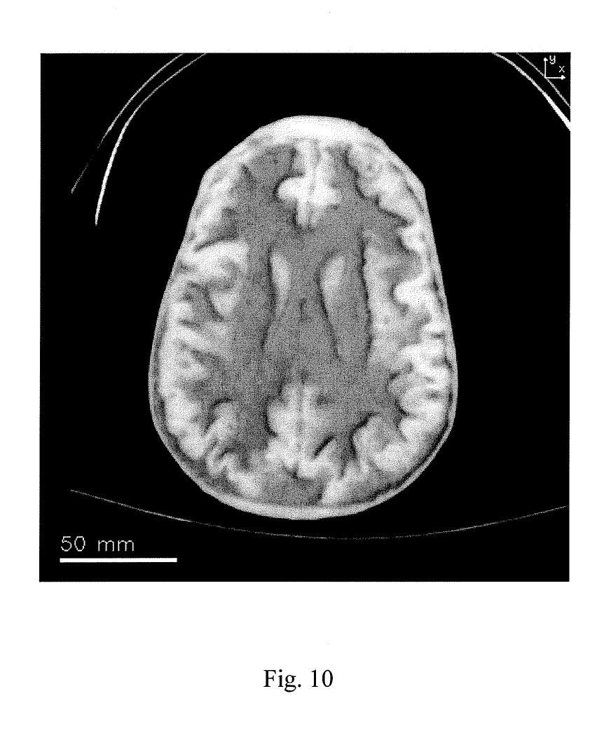

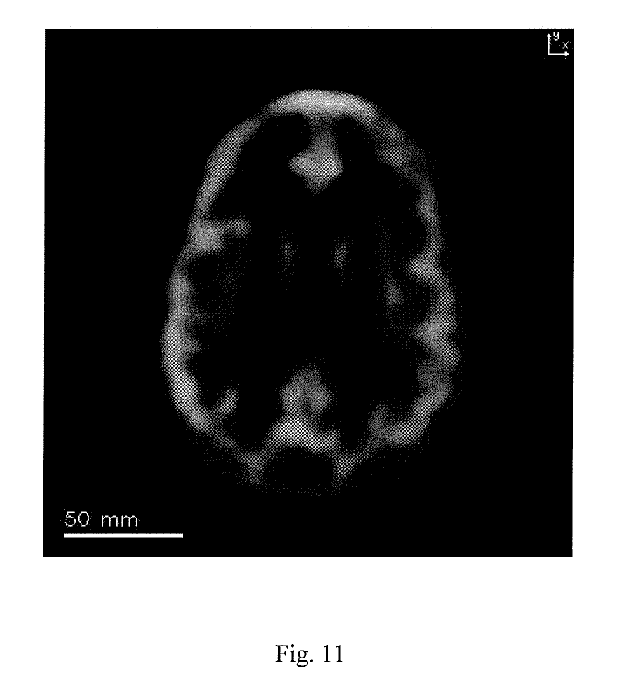

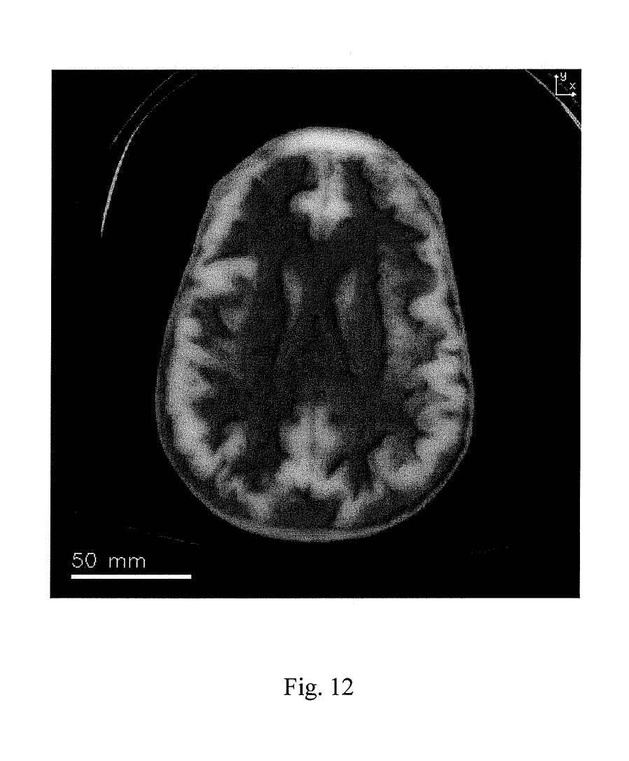

However, unlike Example I above, the present phantom included radiolabeling only within the 15 mm thick cross section, and only the cortical structures, the cerebellum and striata (caudated and putamen) were labeled with 70 kBq/mL of [F18]FDG (at time of imaging), as can be seen in the scanned images shown in FIG. 10, FIG. 11, and FIG. 12. FIG. 9 shows a photograph of the cross-section from the phantom created, whereby the cross-section roughly relates to the cross-section shown in FIG. 7. FIG. 7 is intended to represent a cross-section of the rendered brain that is radiolabeled to allow imaging of the radiolabeled section within the phantom. FIGS. 10, 11, and 12 display images of PET, CT and fused PET/CT scans of the resultant phantoms produced from a Biograph 16 hires PET/CT scanner (Siemens Medical). The PET image was taken in a 10 minute acquisition, using OSEM reconstruction with 2 iterations, and 8 subsets. The CT image was taken with 3 mm slice thickness, 120 kVp, and reconstruction was done with H31s convolution kernel.

### Example III

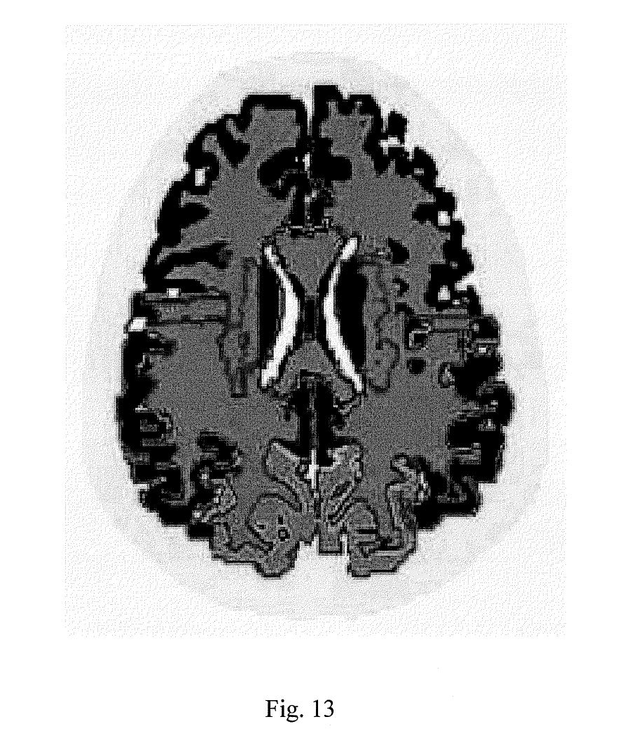

According to another exemplary embodiment, a life-sized phantom modeled after a human brain was produced from the digital brain atlas from the Surgical Planning Laboratory (Boston, Mass.). Utilizing this data, bitmaps were created for layers of the brain separated by 0.007 inches, the thickness of the printer powder layers. Regions of the brain representing white matter were assigned a color index of 105. Regions of the brain representing grey matter were assigned a color index of 255. The resulted in a gray matter:white matter radionuclide concentration ratio of 2.4, similar to the ratio of the relative cerebral metabolic rate for glucose. Parts of brain and head other than grey and white mater were assigned a color index of zero, resulting in no radionuclide concentration in those portions of the printed phantom. An example bit map is shown in FIG. 13.

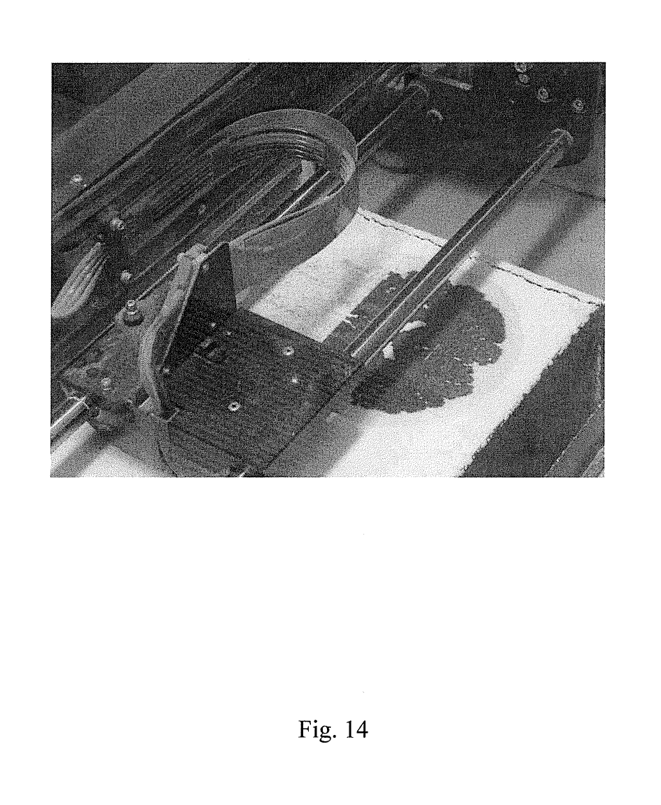

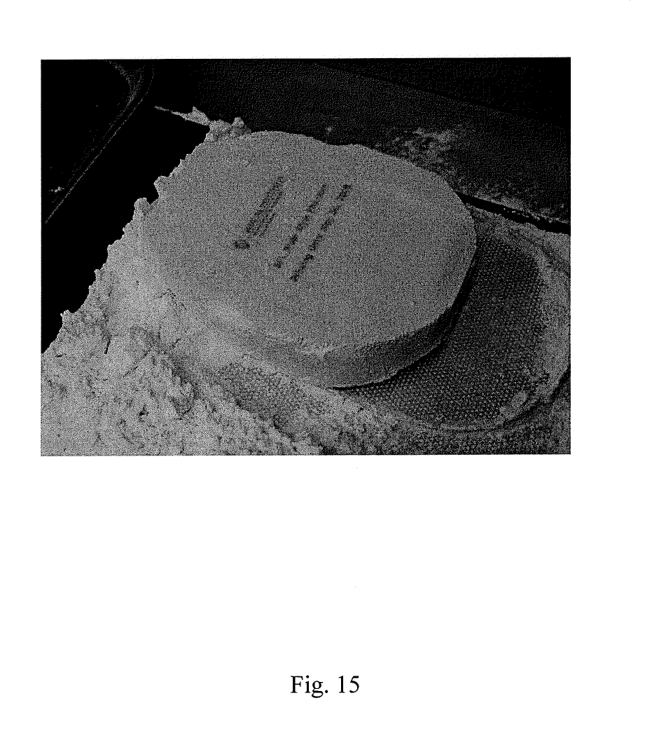

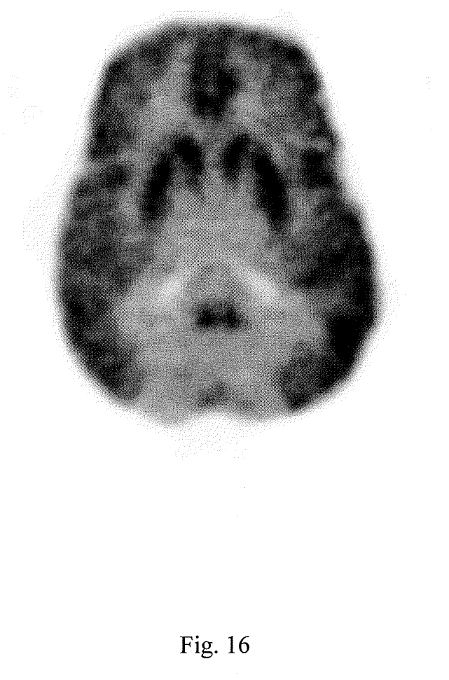

This phantom was printed using a radionuclide/binder mixture consisting of approximately 2 MBq/mL of [18F]FDG. A photograph showing a bit map being printed is shown in FIG. 14. The resulting phantom is shown in FIG. 15. A positron emission tomography image of the phantom, illustrating the distribution of [18F]FDG in the phantom, is shown in FIG. 16.

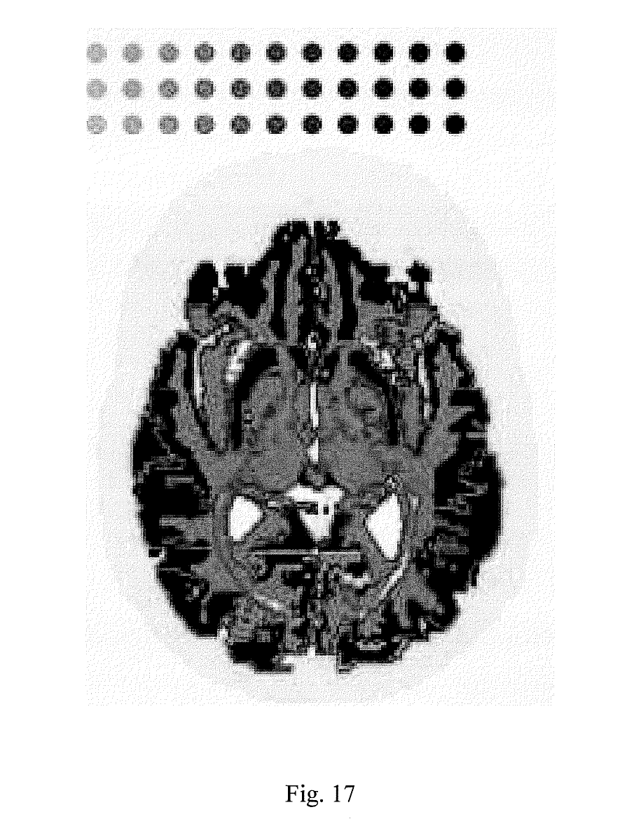

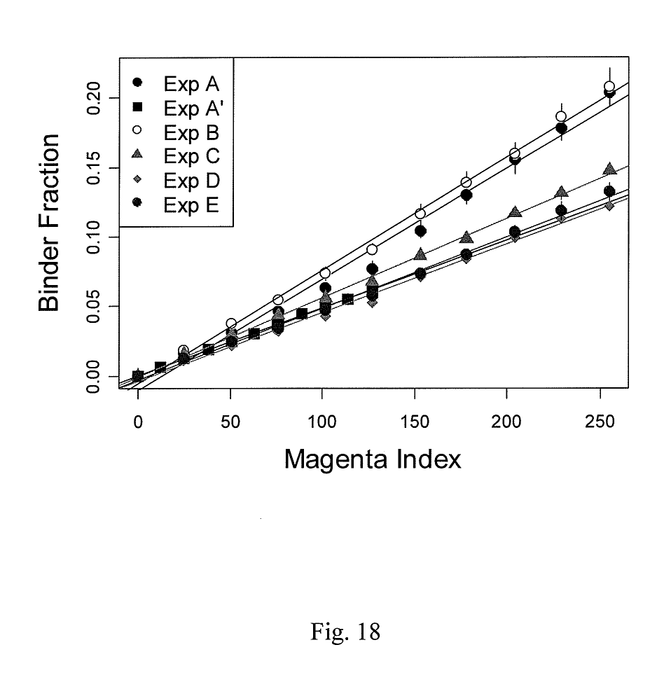

The activity concentration in the phantom was calibrated by printing calibration objects adjacent to the phantom. These consisted of three rows of eleven cylinders, each 7 mm in diameter and 10 mm long. The color index for each row was specified so that the radionuclide concentration ranged from 0% to 100% of the maximum radionuclide concentration in 10% steps. An example bit map including these calibration objects is shown in FIG. 17. These cylinders were then assayed in a gamma counter (Beckman Gamma 8000) and calibrated against a standard 68Ge radioactive source. By plotting the activity concentration in each cylinder versus color index, the radionuclide concentration calibration curve is obtained. An example of such plots, showing the linearity and reproducibility, is shown in FIG. 18.

### Example IV

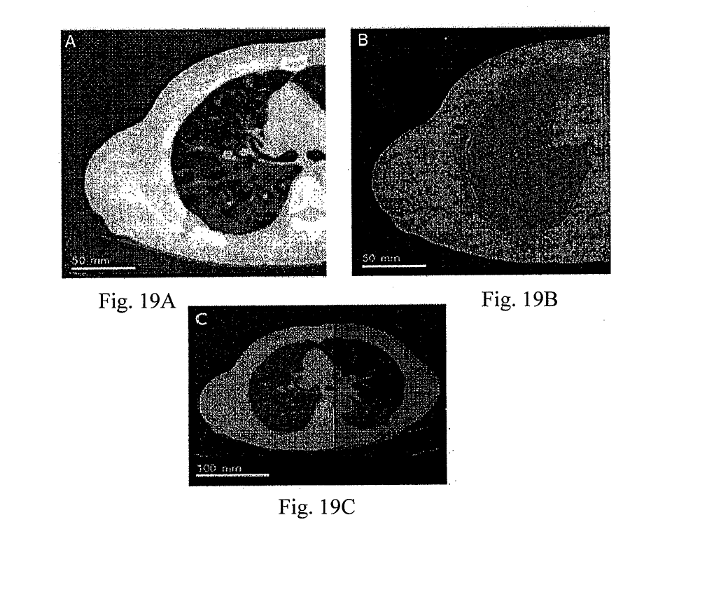

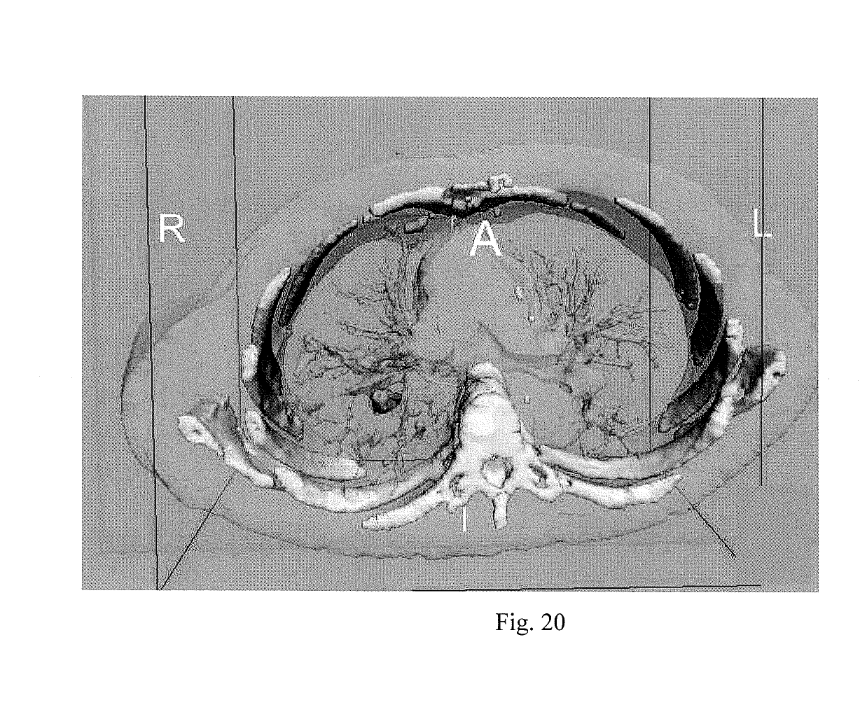

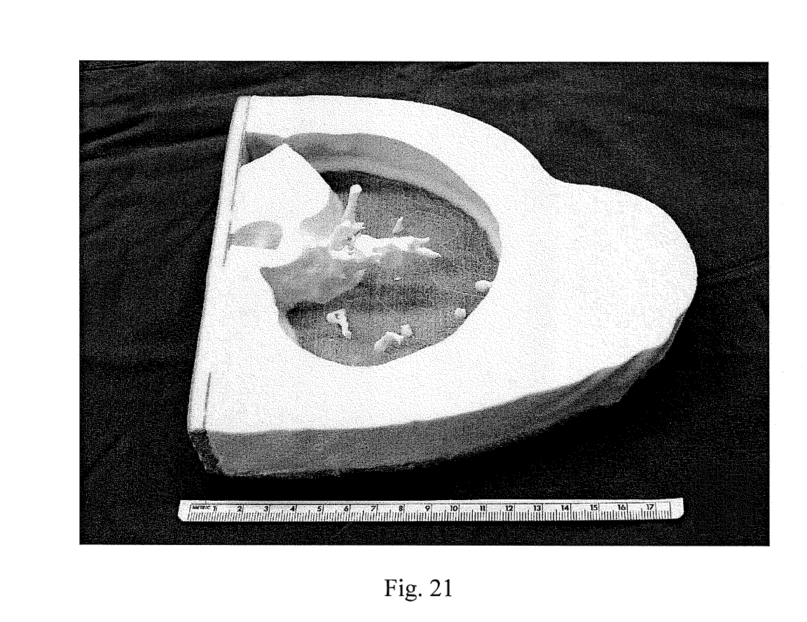

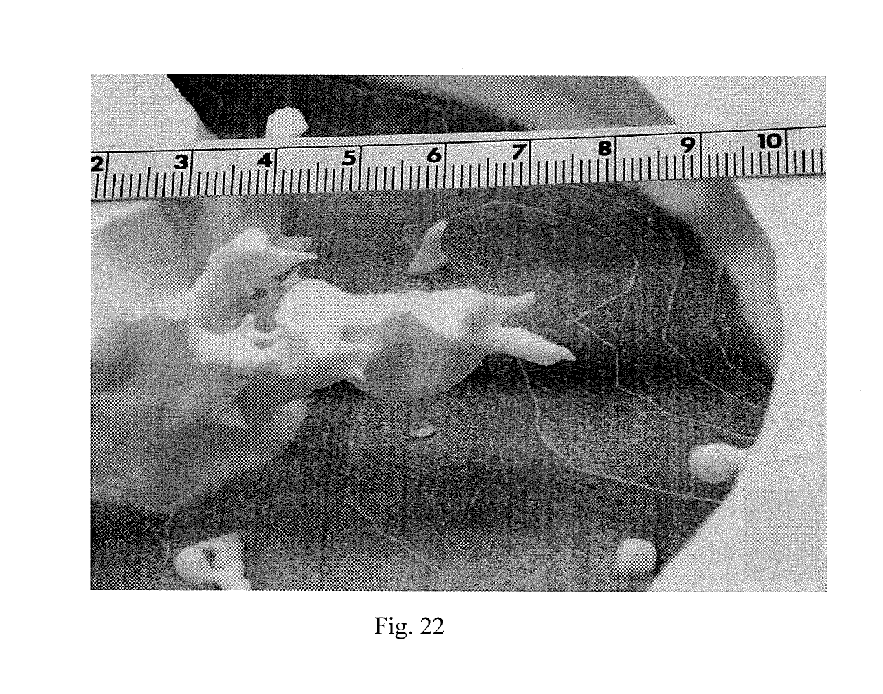

According to another exemplary embodiment, a life-sized phantom modeled after a human lung was produced from data supplied from a clinical PET/CT study. CT data was segmented to represent three different tissues: (1) soft tissue, excluding the lung nodule; (2) the lung nodule; and (3) bone. FIG. 19A is an original CT image of a human torso from which the digital rendering in FIG. 20 was created. From the digital rendering shown in FIG. 20, a 30 mm thick phantom, shown in FIGS. 21 and 22, was created. FIG. 19B shows a CT image of the phantoms of FIG. 21 and FIG. 22. The comparison between the CT images in FIG. 19A and FIG. 19B show the accuracy with which a phantom can be created according to the present application. Finally, FIG. 19C shows an overlay of a CT image of the phantom placed over the original CT image from which the phantom was developed. The light grey portion signifies the original CT image, whereas the dark grey image signifies the CT image of the phantom.

The full-sized human lung phantom was created by utilizing the digital model shown in FIG. 20, with this model being input into a three dimensional printer, namely the Spectrum Z510 (Z Corporation of Burlington, Mass.). Thereafter, a lung phantom of 30 mm thickness as shown in FIGS. 21 and 22 was created according to a method as discussed above in Example I. However, no radiolabeled binder was used in this case. This example illustrates the capabilities of the method for producing varying x-ray attenuations as measured with x-rat CT imaging. FIGS. 21 and 22 show the resulting phantom, with a ruler marked in centimeters for scale.

### Example V

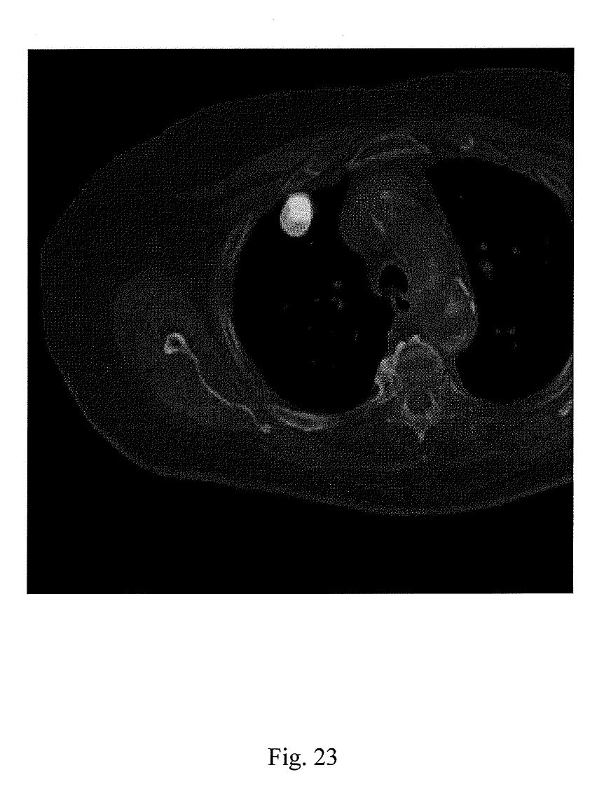

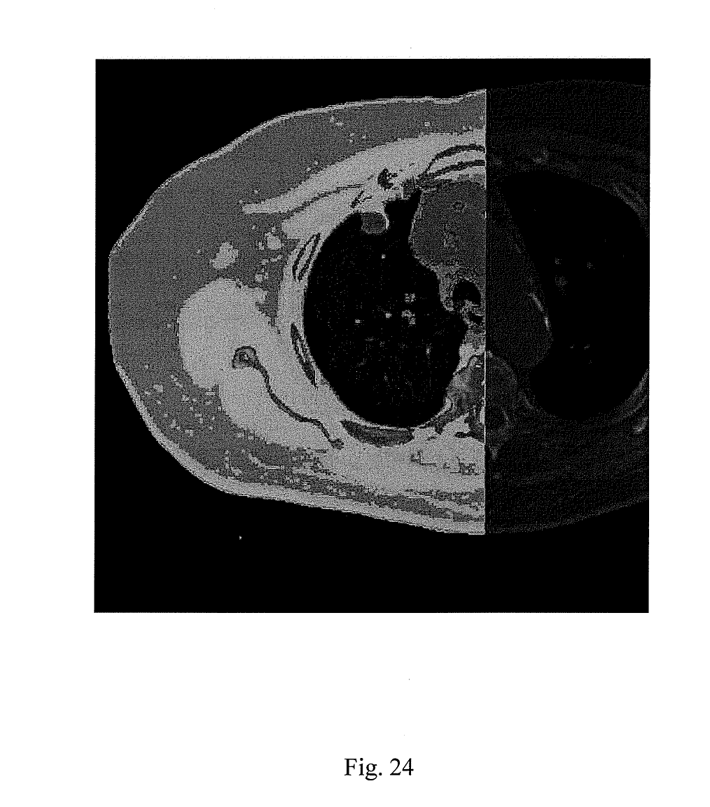

According to another exemplary embodiment, a life-sized phantom modeled after a human lung was produced from clinical x-ray CT and PET data. Utilizing this data, bitmaps were created for layers of the body separated by 0.007 inches, the thickness of the printer powder layers. Regions of the body representing lung, tumor, muscle, fat, mediastinum, and bone were identified from the CT image. Color indexes for each region were assigned to produce radionuclide concentration ratios similar to those seen in the PET image. FIG. 23 shows an example image from the PET/CT data that this phantom is based on. An example bitmap is shown in FIG. 24.

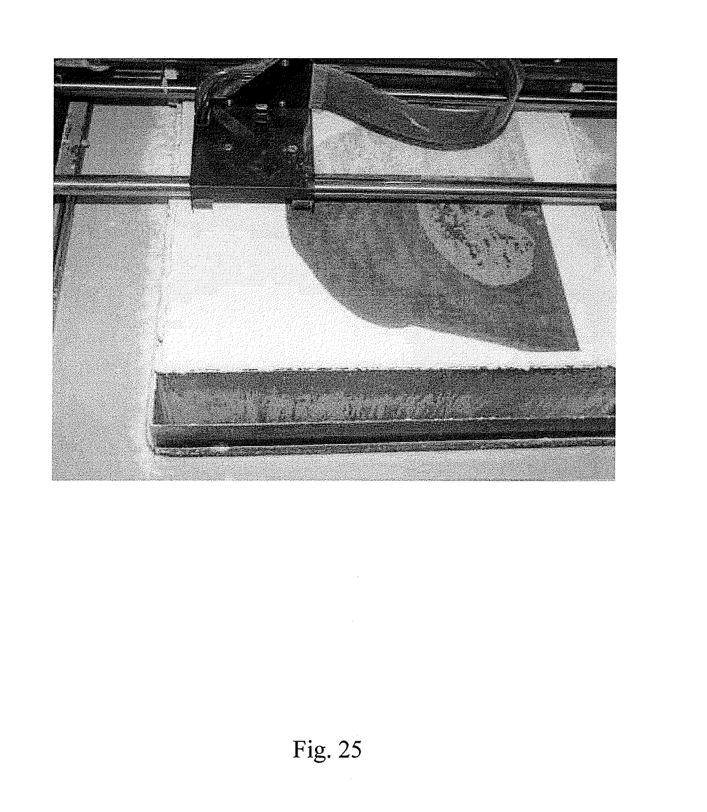

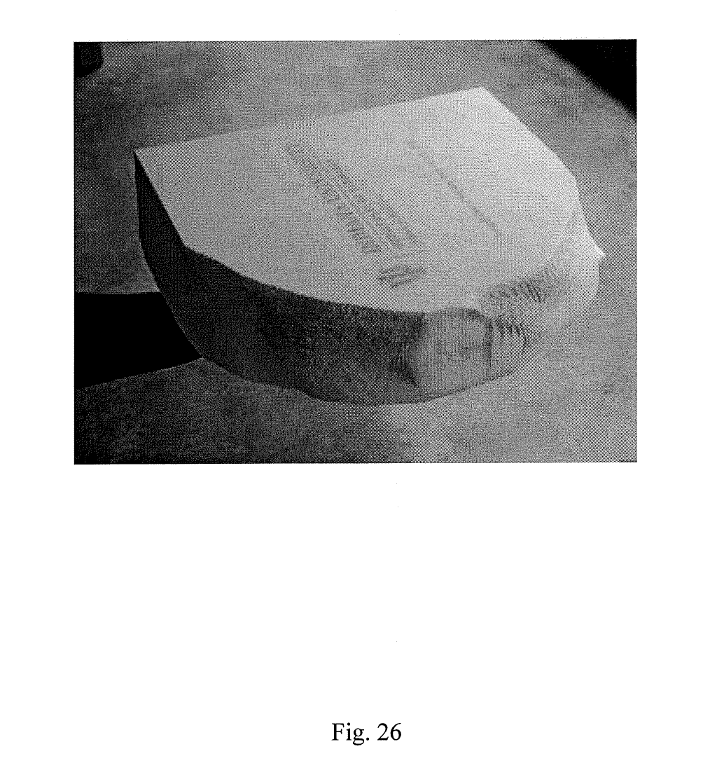

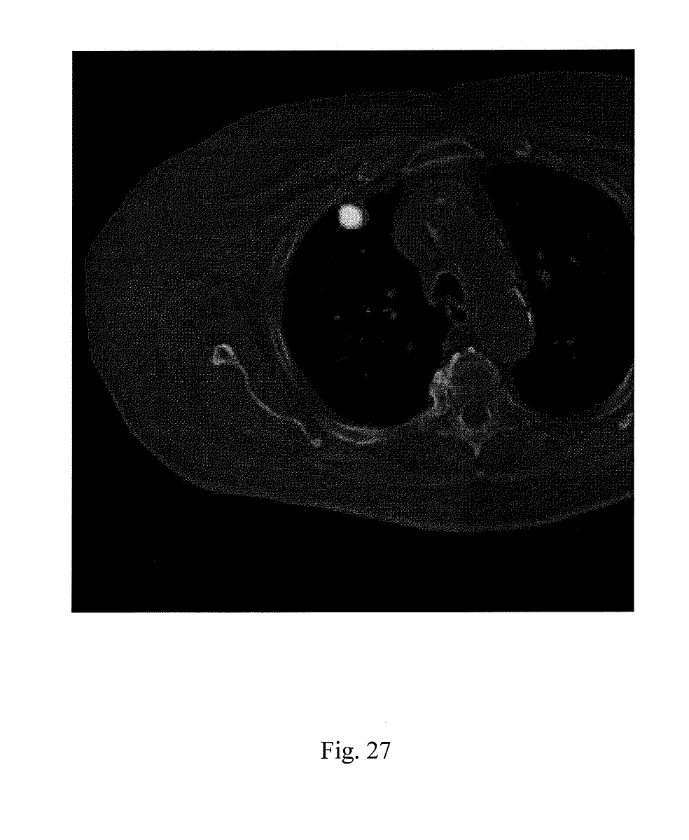

This phantom was printed using a radionuclide/binder mixture consisting of approximately 2 MBq/mL of [18F]FDG. A photograph showing a bit map being printed is shown in FIG. 25. The resulting phantom is shown in FIG. 26. A positron emission tomography image of the phantom, illustrating the distribution of [18F]FDG in the phantom, is shown in FIG. 27.

### Example VI

According to another exemplary embodiment, a mixture of binder and bismuth oxide nanoparticles (Afal Aesar, Ward Hill, Mass.) is being developed. These particles have high x-ray attenuation coefficient due to the bismuth. Concentrations of approximately 0.03 M and 0.06 M are expected to result in phantoms with x-ray attenuation coefficients similar to soft tissue and bone, respectively. A concentration of 1M is approximately 0.21 g bismuth per mL, so these mass concentrations are on the order of 0.1 g/mL. These nanoparticles are less than 100 nm in size, so they are not expected to interfere with the printing process. By using multiple concentrations of binder, binder-radiopharmaceutical, binder-bismuth oxide, and mixtures thereof, phantoms with x-ray attenuation coefficients matching that of soft tissue (binder+0.03M bismuth oxide), bone (binder+0.06 M bismuth oxide) and lung (no binder), and radioactivity concentrations appropriate to those tissues can be produced. Thus this application allows us to manufacture phantoms that match realistic anatomy in size, detail, x-ray attenuation coefficients and radioactivity concentration.

Although the embodiments above have been described in detail with reference to preferred embodiments, variations and modifications exist within the scope and spirit of the invention as described and defined in the following claims. Practitioners will appreciate that phantoms with well-defined geometries that accurately model radiolabeled tracer concentrations and photon attenuation coefficients are suited for characterization of imaging systems, but are not as well suited for evaluating methods sensitive to detailed anatomical structure, such as algorithms for monitoring tumor response. As such, the highly detailed and tunable phantoms allow for segmentation of complex tissue formation, thereby allowing phantoms to display the shape and activity distribution of a realistic anatomy, including diseased tissue states such as tumor tissue and the complex structures of the brain. The complex geometries and tunable radioactivity according to the present application provide a phantom and method of making phantoms that opens new doors in evaluation of automated image analysis systems and the study of tissue imaging. Such detailed phantoms, imaged at sites involved in clinical trials, would be valuable in evaluating inter-site consistency and accuracy. Further, testing of phantom production using methods disclosed within the present application resulted in only 2% relative standard deviation of the activity of multiple identical phantoms. Further, activity in unlabeled parts was less than 2% of adjacent labeled regions.

While various embodiments of phantoms, as well as methods of their production and use, have been described in considerable detail herein, the embodiments are merely offered by way of non-limiting examples of the invention described herein. Many variations and modifications of the embodiments described herein will be apparent to one of ordinary skill in the art in light of the this disclosure. It will therefore be understood by those skilled in the art that various changes and modifications may be made, and equivalents may be substituted for elements thereof, without departing from the scope of the invention. Indeed, this disclosure is not intended to be exhaustive or to limit the scope of the invention. The scope of the invention is to be defined by the appended claims, and by their equivalents.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps disclosed herein should not be construed as limitations on the claims. In addition, the claims directed to a method and/or process should not be limited to the performance of their steps in the order written, and one skilled in the art can readily appreciate that the sequences may be varied and still remain within the spirit and scope of the present invention.

It is therefore intended that the invention will include, and this description and the appended claims will encompass, all modifications and changes apparent to those of ordinary skill in the art based on this disclosure.

What is claimed is:

1. A phantom for use in medical imaging comprising:
a. a powdered material operable to be bound to itself or at least one other powdered material with a binder composition to form a three dimensional model;
b. a binder composition operable to be applied to the powdered material to form a solid or semi-solid material when cured, and wherein the binder composition is further operable to be combined with a radioactive material, x-ray contrast material, or combination of a radioactive material and x-ray contrast material; and
c. at least one material chosen from the group consisting of a radioactive material, an x-ray contrast material, or a combination of a radioactive material and x-ray material, and combined with the binder composition.

2. The phantom of claim 1, whereby the phantom is modeled after a three dimensional rendering of an anatomical feature, and whereby the phantom displays a vertical deviation from the three dimensional rendering of the anatomical feature that is less than or equal to about 0.50 mm.

3. The phantom of claim 1, whereby the phantom is modeled after a three dimensional rendering of an anatomical feature, and whereby the phantom displays a vertical deviation from the three dimensional rendering of the anatomical feature that is less than or equal to about 0.25 mm.

4. The phantom of claim 1, whereby the phantom is modeled after a three dimensional rendering of an anatomical feature, and whereby the phantom displays a vertical deviation from the three dimensional rendering of the anatomical feature that is less than or equal to about 0.18 mm.

5. The phantom of claim 1, whereby the phantom is modeled after a three dimensional rendering of an anatomical feature, and whereby the phantom displays a horizontal deviation from the three dimensional rendering of the anatomical feature that is less than or equal to about 0.2 mm.

6. The phantom of claim 1, whereby the phantom is modeled after a three dimensional rendering of an anatomical feature, and whereby the phantom displays a horizontal deviation from the three dimensional rendering of the anatomical feature that is less than or equal to about 0.1 mm.

7. The phantom of claim 1, whereby the phantom is modeled after a three dimensional rendering of an anatomical feature, and whereby the phantom displays a horizontal deviation from the three dimensional rendering of the anatomical feature that is less than or equal to about 0.08 mm.

8. The phantom of claim 3, whereby the phantom is modeled after a three dimensional rendering of an anatomical feature, and whereby the phantom displays a horizontal deviation from the three dimensional rendering of the anatomical feature that is less than or equal to about 0.1 mm.

9. The phantom of claim 1, whereby a detectable region comprising a radioactive material, x-ray contrast material, or combination of a radioactive material and x-ray contrast material is separated by an additional detectable region comprising a radioactive material, x-ray contrast material, or combination of a radioactive material and x-ray contrast material by a distance of less than or equal to 0.014 inches.

10. The phantom of claim 1, whereby a detectable region comprising a radioactive material, x-ray contrast material, or combination of a radioactive material and x-ray contrast material is separated by an additional detectable region comprising a radioactive material, x-ray contrast material, or combination of a radioactive material and x-ray contrast material by a distance of less than or equal to 0.007 inches.

11. The phantom of claim 1, whereby a detectable region comprising a radioactive material, x-ray contrast material, or combination of a radioactive material and x-ray contrast material is separated by an additional detectable region comprising a radioactive material, x-ray contrast material, or combination of a radioactive material and x-ray contrast material by a distance that is substantially zero.

12. The phantom of claim 8, further wherein the at least one material comprises two or more materials selected to represent the density of two or more different tissues or radiolabeled tissues shown in the three dimensional rendering of an anatomical feature.

13. The phantom of claim 8, whereby the three dimensional rendering of an anatomical feature is produced through data obtained from a computer-aided design technology.

14. The phantom of claim 8, whereby the three dimensional rendering of an anatomical feature is produced through data obtained from an imaging technology.

15. The phantom of claim 14, whereby the imaging technology is selected from a group consisting of computed tomography, magnetic resonance imaging, x-ray technology, positron emission tomography, single photon emission computed tomography, radionuclide imaging, computed radiography, and ultrasonography.

16. The phantom of claim 8, whereby the at least one material chosen from the group consisting of a radioactive material, an x-ray contrast material, or a combination of a radioactive material and x-ray material combined with the binder composition is selectively added to the powdered material to form at least one cross section of the three dimensional rendering of an anatomical feature.

17. The phantom of claim 16, further comprising a first cross section and a second cross section of the three dimensional rendering of an anatomical figure, whereby the second cross section of the three dimensional rendering of an anatomical figure is iteratively formed upon the first cross section of the three dimensional rendering to form a three dimensional phantom.

18. A method of producing a phantom, the method comprising the steps of:
obtaining a digital model of a structure;
introducing the digital model to a three-dimensional printer; whereby
the three-dimensional printer comprises a printing mechanism, a powder, and at least one binding agent;
creating a structural layer, whereby the process of creating the structural layer comprises distributing a layer of the powder with the three-dimensional printer on a solid surface, and distributing a layer of the at least one binding agent on the powder, whereby the binding agent adheres upon contact with the powder;
repeating the process of creating the structural layer at least one time to form a phantom.

19. The method of claim 18, wherein the digital model is created using a computer-aided design technology.

20. The method of claim 18, wherein the digital model is created using data from an imaging technology.

21. The method of claim 18, wherein the imaging technology is selected from the group consisting of computed tomography, magnetic resonance imaging, x-ray technology, positron emission tomography, single photon emission computed tomography, radionuclide imaging, computed radiography, ultrasonography.

22. The method of claim 18, wherein the digital model is converted by a processor to a data style acceptable to the three-dimensional printer.

23. The method of claim 22, wherein the data style is a stereolithography style.

24. The method of claim 22, wherein the data style is a bitmap style.

25. The method of claim 18, wherein the powder is cellulose-based.

26. The method of claim 18, further comprising distributing a series of concentrations of radionuclide in a specified pattern.

27. The method of claim 18, whereby a first phantom produced by the method has equal to or less than about 3% relative standard deviation of an activity when compared to a second phantom produced by the method.

28. The method of claim 18, whereby a first phantom produced by the method has equal to or less than about 2% relative standard deviation of an activity when compared to a second phantom produced by the method.

29. A method of quantitative evaluation of an imaging system using the phantom of claim 1, the method comprising the steps of:
providing the phantom with a previously determined image;
providing an imaging system;
visualizing the phantom with the imaging system to obtain a first image of the phantom;
determining the variation between the first image and the predetermined image using a processor.

30. The method of claim 29, further comprising calibrating the imaging system, whereby the method of calibrating comprises the steps of altering at least one variable in the imaging system so that visualization of the phantom with the imaging system produces a second image is substantially the same as the previously determined image.

31. A method of representing a physiologic condition using a phantom of claim 1, wherein the method comprises the steps of:
creating a phantom having an anatomic and non-uniform representation of an anatomic feature substantially identical to the anatomic feature;
verifying that the image developed of the phantom through use of an imaging system is substantially identical to an anatomic image developed of the anatomic feature through the use of the imaging system.
